(19) United States
(12) Patent Application Publication
(10) Pub. No.: US 2023/0089719 A1
(43) Pub. Date: Mar. 23, 2023

(54) EMERGENCY VISUAL WARNING SYSTEM

(71) Applicant: RCA-D Ingenieria, Automatizacion y Servicios SPA, Santiago (CL)

(72) Inventors: Francisco Javier Riquelme Tilleria, Santiago (CL); Ariel Jimenez Varela, Santiago (CL)

(21) Appl. No.: 17/905,026

(22) PCT Filed: Feb. 25, 2020
(86) PCT No.: PCT/CL2020/050013

§ 371 Date: Aug. 25, 2022

(51) Int. Cl. B60Q 1/52; B60Q 1/08; B60Q 1/26; B60Q 1/00

(52) U.S. Cl. CPC B60Q 1/52; B60Q 1/085; B60Q 1/2696; B60Q 1/0094; B60Q 2400/20

(57) ABSTRACT

Design of identification and visual protection system for mining equipment, vehicles and people exposed to possible high potential interactions, this system is the combination of different lighting techniques, which together offer a new product with the advantages of delivering a Greater capacity to be visualized in the field, preventing identification and warning problems in mining equipment.

Its form and use can help reduce the risks and exposure of equipment, vehicles and people where they can be implemented. Considerably increasing the identification distance, even without any external light emission.

This application is aimed at an emergency visual warning system, in mining, industry, manufacturing or any production process that may be relevant in visual communication in accessories and equipment. Specifically, this system incorporates the different communication, control and automation technologies to control devices that change their light emission or identification depending on an alert, condition or order in the different application systems, using in all the devices that can be connected to the system, high visibility visual technology, ensuring vision even without the incidence of external light.

### STATE OF THE ART

Currently, in the different industries, processes and activities that may present a risk to people and equipment, visual warning systems have been based on sound, sensory and visual warning techniques, the latter being the least portable both due to their cost as well as its limited ability to conform to different surfaces, sizes and shapes that make this alert method the least portable and used of all.

The different environmental conditions such as darkness, use of external energy sources, limitations or conditions of the people who can interact with these signs, mean that the inconveniences of their use are assumed by the processes as characteristics of these technologies but, in turn, the potential interaction with other business areas, people or processes make their use mostly inefficient and little used.

Another technical drawback of current technologies is the constant use of conventional light emission systems where each one has particular benefits and weaknesses such as size, high energy consumption, different levels of fragility, different electrical disturbances to the source and the high costs of its implementations prevent the possibility of being used in technological developments with high visual impact. That is why substitute mechanisms are also used to be applied in positions, places and conditions, where the previous ones present immediate damages, operational, security, technical or commercial complications, being an effective but not efficient solution since it leaves important gaps of security and effective communication, such as the Andon system, which has alert characteristics only with traffic lights, which means that it cannot be implemented abroad and attached to mobile devices, creating important limits for the inclusion of some areas of society that are restricted or exposed by the different opportunities that current alert techniques have.

This is how the need to be able to provide the different organizations, infrastructures, industries and vehicles with better conditions that they can deliver to users, operators, work teams and people in general, including those who have some type of hearing limitation, in cases of generalized or localized emergencies, of a visual security tool that can be very basic or completely automated is manifested or born.

Although no invention like the one proposed in this application has been found, the current state of the art is set out below.

Document WO2013030427 describes an Intelligent control system for priority vehicles, which acts on the already existing elements and explained in the document in reference in which, despite having a signaling equipment with intelligent control, providing the ability to centralize information and with the possibility of making recordings through a public address module. However, the system of the invention that is claim includes as a device the capacity for permanent display, as well as the ability to control the status of these remotely with a bidirectional control that provides the system with the ability to visually identify each device. one of the devices included in the system.

The document ES1075230 describes a visual alarm for public or private vehicles where, as identified in its characteristics and all the references indicated in the document, the emergency signals, unlike this described document, are silent and directed, creating a large information gap between what happens and its environment. However, the system of the present invention provides the ability to fully illuminate the devices, depending on their configuration and mounting, creating a complete 360° visual warning of the vehicle so that its visual incidence is integrated, likewise it incorporates the ability to always be visible under conditions even if the control system failed or was turned off by the user.

Document ES2681979 describes a method for warning and alerting a person in danger within an area that includes a method of warning portable devices of people who are exposed to risk. However, the present invention provides the ability to be able to visually alert everyone who enters the area, regardless of the existing communications and data transmission condition, making concentration on the execution of the work complete and not depending on the visualization of additional devices, this present invention apart from ensuring the visualization in all cases even without light, provides to different people, device assets or sensorizations that by alerting local or external of any risk condition that may have to be communicated in the different areas and in all its extension.

Document ES2353473 describes a procedure and device for transmitting light, which is installed in clothing attached to materials that facilitate the removal of elements in clothing with “velcro” material. However, the system of the present invention provides the ability to always be visible since, added to the nanoled technique, three more sheets are added that ensure the visualization of people or devices even when the electronic elements fail or when there is no external light, this device presented in this invention provides the charging and emission capacity with control and visualization systems that are part of the clothing, and can even pass cleaning processes and extreme work; In addition to the visual alert characteristics, it has a satellite positioning system that will be activated only when the alert or emergency is activated by the user of the device and the constellation conditions allows it.

Document ES1237220 describes a breakdown or emergency warning and signaling device comprising a portable device that is mounted on vehicles, which through communication with a mobile application generates the reporting and activation of visual alerts, the latter with LED technology, portable and external, likewise with all the existing elements also explained in the previous reference. However, the system of the invention does not use an application to be able to communicate an emergency state, likewise the lighting devices made up of the different layers, form the main lighting device that ensures the visibility of the vehicle at all times, even without external light. The interconnection that exists between the voltage inverter module and the network is multiprotocol, so connectivity is assured and between devices via bluetooth or Wi-Fi.

Document ES2023059 describes an electronic device of automatic light change comprising a device that controls and automatically changes vehicle lights. However, the present invention does not control the transit lights of the vehicles, it controls the lighting devices that are an integral part of this presentation of the invention, either in manual or automatic activation conditions.

Document WO2012143586 which describes an emergency lighting device in tunnels, comprises a fixed LED light emitting element, attached to the walls of the tunnels, these devices positioned in sectors of the tunnel provide focused lighting according to the description of the document, assembled according to the instructions given in the reference. However, the present invention applies high visibility lighting technology to the equipment that circulates in the tunnel sections as well as to the structures of the tunnels themselves of the lighting devices that are controlled or activated locally or remotely as described in the invention application.

### DESCRIPTION OF THE FIGURES.

FIG. 1: Represents the basis of the filed invention, it is the combination of 3 or 4 unity lighting techniques, with a high degree of engineering, this combination can be added to a fourth depending on the extension of the facilities to implement each one of them detailed below: (1) Lime green reflective band base or another engineering grade color of 70 candles of power; (2) Intermediate band of high visibility photoluminescence with autonomy of up to 4 hours and light power of 74 candles; (3) Core with flexible nanoled electronic band of only 0.2 mm. thick with light power of 120 candles, core with color change characteristics, it is responsible for alternating the luminosity of each selected color depending on its configuration; (4) 20 micron Floor Graphics laminate plus superior engineering grade nanotech protective varnish, insulation, and hi-visibility base tape container.

FIGS. 2 and 3: Represents a device that integrates the filed invention, a portable textile device, with a high level of visualization and directed connectivity, this device is made up of the following details: (5) high-power and multicolor laser/LED indicator , which will flash if the equipment is activated locally, signaling coupled to nano satellite GPS that ensures the correct location of the person carrying it in outdoor locations; (6) Flat button, flat contact engineering element that will be in charge of delivering to the portable control device the SOS signal that will activate the portable device; (7) high visibility tape based on the invention that contains the visual assurance techniques described, an implement that will be an intrinsic part of the device; (8) flexible solar sheet that will be an intrinsic part of the clothing, responsible for recharging the batteries that power the portable textile device; (9) local control and power module, responsible for receiving external or local information, processing it and activating the modules of normal or emergency work, device that feeds the modules (5), (6), (7), (10) with energy; (10) light emission module that feeds the optic fiber module, which will generate the full brightness of the device.

FIG. 4: Represents a device that integrates the present invention, a base device of the invention that is distributed in a vehicle (4×4 truck) and can be indistinctly in mining machinery, agricultural machinery, equipment and emergency vehicles, as in fixed or mobile structures. such as (tunnels, tambourines, containment barriers and others), which distributed form the mobile visual warning system that is made up of the following details: (11) High visibility tape on the side of the vehicle; (12) High visibility tape (FIG. 1) the front of the vehicle; (13) high visibility tape (FIG. 1) at the rear of the vehicle; (14) high visibility tape (FIG. 1) positioned on the top of the vehicle; (15) main power and control module, electronic equipment that centralizes the power supply of all the high visibility tapes, communicates the equipment with the different mobile or fixed devices that can be part of the visual alert system, is in charge of transmitting and receiving the information from the central and processing the different levels of work that can be configured.

FIG. 5: Represents the operation and base logic of the system, providing a visual description of the operation that the full system will have; (15) main power and control module, electronic equipment that centralizes the power supply of all the high visibility tapes or light emission system (10) defined, communicates the equipment with the different mobile or fixed devices that can be part of the system visual alert, in addition to transmitting data to local or remote servers that are part of the system, (16) Local or remote servers, responsible for centralizing the information, processing the data to the different control modules (15) that are connected, they are also what receives the activation orders in case of being requested externally; (17) external activation and conversion module, system that allows the system to be able to react to an emergency warning, which is stored in the servers (16) and sent to each module (17) that has interaction with the emergency, module that It is also responsible for transforming the data so that they can be used in external systems.

### DETAILED DESCRIPTION OF THE INVENTION

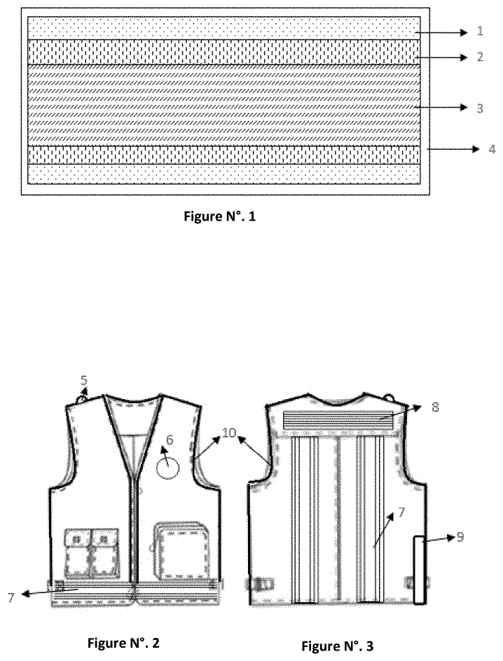

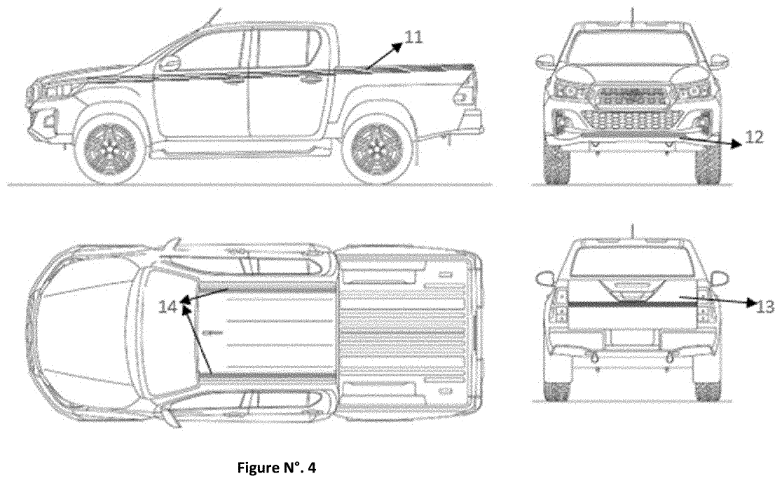

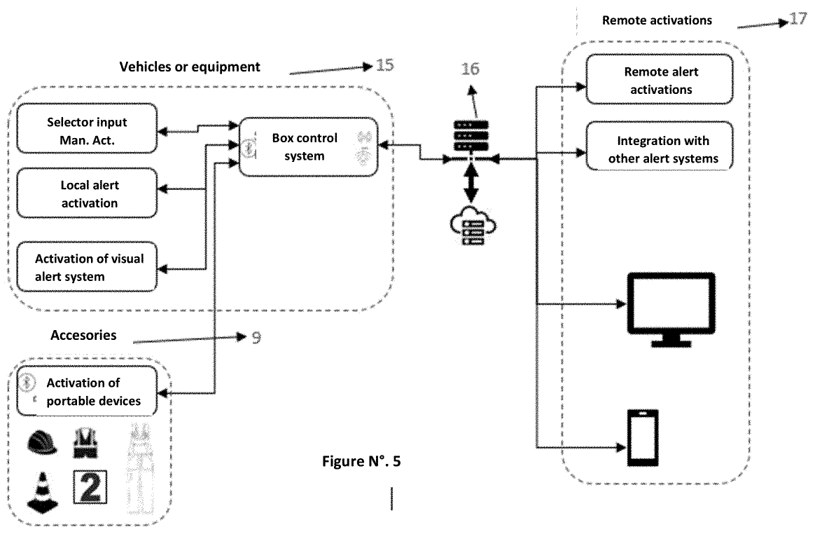

The system has a high visibility base device (FIG. 1) it will be installed in mobile equipment (regardless of its brand, model or shape) it will replace the elements that currently provide the limited ability to be seen (reflective tapes of different models and brands), by the device, it will be configured by at least 2 and a maximum of 4 light signaling techniques , each one of which makes up this fundamental development to be able to apply complete visual safety in the visual emergency alert system . The devices that can be incorporated can be from objects, vehicles, clothing or any special requirement that may, depending on need, have the ability to be displayed in both conditions (normal/emergency).

The system is made up of 4 layers of products, which can vary in color and shape, according to the different applications, equipment or requirement that may be requested by the different end customers.

For this invention presentation, it was applied to a mining truck, which presents quantitative and qualitative improvements in the ability to be detected in normal and special conditions such as zero lights, low light and environmental pollution, another improvement is detection at a great distance.

This device is made up of a layer of engineering-grade prismatic reflector, which is capable of reflecting daylight, artificial light from other equipment or sources (1), this element has been reinforced with an additional adhesive to ensure and correct possible failures in its adhesion with the selected surface, another advantage of this design (1) is its degree and measure which provides a complementary area for the installation of other techniques. Once the luminescent reflector base is fixed, the installation of the Photoluminescent system (2) is carried out, which has a Base Engineer degree, with a capacity of 74 Candles, which is in charge of being able to deliver an emission of light independent of its source, since it is charged directly with UV rays, delivering a constant emission between 4 to 12 Hrs. , and can be artificially charged with a UV light beam in case it cannot be directly exposed to the sun, which will depend on the different configurations that customers may request. In order to provide the security that the equipment, elements, people and any requirement that is requested, have the certain capacity to be seen, the third layer of last generation nanoled element (3) is added to this configuration, it is the thinnest light source on the market, based on the production of millions of microscopic leds, through the creation of programmed layers of different conductive and luminescent elements, activated by high-tech and low-consumption electronic frequencies. Our nanoled sheet technology is only 0.2 mm thick, making it the thinnest and most versatile electronic light source that exists, with an approximate useful life of 50,000 hours. Within its innumerable design features, this application is flexible, dimmable, resistant and efficient, with the possibility of multicolors. And, finally, to ensure the installation of our system, a coating (4) of 20-micron Floor Graphics sheet with incorporated nanotechnology is added, to seal and ensure the hermeticity of the kit, added to this a special nanotechnological varnish to provide the system with the ability to lower the percentage of adhered contamination.

The control and power unit consists of a developed electronic element, which will deliver the ability to bidirectionally control, monitor and alert the devices connected to it, positioning this development as the only one of its kind, capable of reporting upcoming events, high potential exposures or imminent risks that may be inefficient with conventional visual alert systems, the processor's operating logic contemplates the different configurations that can be enabled in the model, from manual identification of danger or risk, to automatic detection systems, which with sensorization and artificial intelligence (AI) can determine the application of the corresponding visual alerts, and can even sectorize the different routes or evacuation routes to be able to reach the emergency zone. In the different industries where there is the possibility of having the interaction of the personnel, provided with a portable device, it will be possible to be informed and report when any manual or emergency command activates the control system, visually indicating the “emergency” condition that will be activated locally, remotely or automatically and will change the color of all the devices connected to the system, or according to the sectoral programming that the system is loaded, this feature will make the emergency states noticeable not only by the person that is carrying the device, if not by all the personnel that surrounds it or is in line of sight for an approximate radius of 500 meters in the dark and 100 meters in daylight.

The Applications of this development, as we mentioned before, are multiple, its parts and pieces function autonomously as a local system, a global system. Among the most notable features is the option to be able to geo-position the teams that comprise it and activate local alerts with basic positioning systems, such as satellite positioning in the most complex systems, providing this development with optimal control and alert conditions.

Amendments to the claims:

1. An emergency light projection system to be installed in mobile vehicles such as mining, forestry and emergency vehicles that increases safety in this and that has high visibility, constant visibility and forced visibility, controlled locally (manual), remote (Automatic), with characteristics and configurations in unicolor, bicolor or customized CHARACTERIZED because it comprises a set of light-emitting sheets (2,3) and light reflecting (1), in which the light-emitting sheet is controlled through a bidirectional controller module that activates/deactivates the system.

2. A projection system according to claim 1 CHARACTERIZED because it comprises a light reflective sheet and is arranged in the length and width limited by the corners of the vehicle.

3. A projection system according to claim 1. CHARACTERIZED because the emitting sheet is photoluminescent and is located between the reflective sheet and a nanoled sheet, centered on a coating.

4. A projection system according to claim 1 CHARACTERIZED because a nanoled sheet is located centered and on the photoluminescent sheet and is electrically powered from a voltage inverter controller module, activated manually or automatically.

5. A projection system according to claim 1 CHARACTERIZED because a 20 micron Floor Graphics sheet (4) contains the other sheets.

6. A projection system according to claim 1 CHARACTERIZED, because it comprises a nanotechnological varnish.

7. A projection system according to claim 1 CHARACTERIZED, because it comprises two controller modules, where 1 is a voltage inverter, and the second is a remote emergency modulator.

8. A projection system according to claim 1, on the voltage inverter modulator CHARACTERIZED because it in charge of electrically feeding the sheet mentioned in claim number 4 which is made up of nanoled, this will deliver the necessary signal for the correct flashing of the sheet, it is activated Manually or Automatically.

9. A projection system according to claim 8, on the voltage inverter modulator CHARACTERIZED because it includes nano circuits, responsible for optimizing space, providing the portability and cooling capacity necessary for prolonged use.

10. A projection system according to claim 8, on the voltage inverter modulator CHARACTERIZED because it includes internal microprocessors, which contain the programming to be able to determine the operating logic of the system, being able to discriminate the source of the activation request, prioritizing, according to internal logic, preconfigured actions.

11. A projection system according to claim 8, on the voltage inverter modulator. CHARACTERIZED because it includes an optimized power source , in charge of powering in a special way, the processors and inverters for the activation of the device.

12. A projection system device CHARACTERIZED because it includes peripheral sensors, in charge of being able to deliver information about the environment, automatic risks or emergency conditions that may trigger the activation of the system, thus ensuring its use in high-risk events.

13. A projection system according to claim 12 CHARACTERIZED because it comprises an automatic positioning system, which consists of two configurable alternatives, high precision normal gps or satellite gps, which will deliver in case of level 1 activation, the physical position of the issuer; This will deliver the geographical position remotely, automatically and by alert, controlled with special permissions on authorized devices and with the Android/Apple application available.

14. A projection system according to claim 8, on the voltage inverter modulator. CHARACTERIZED because it includes a multi data connection system, a system with the ability to hyper connect information to central servers, with wireless techniques (GSM—GPRS—BT—Wifi—3G—4G and 5G) .

15. A projection system according to claim 12 CHARACTERIZED because it comprises a multi data connection system, system with the ability to connect the information of the control module to the devices, with wireless techniques (BT - Wifi).

16. A projection system according to claim 12 CHARACTERIZED because it comprises a state change control, where the system will deliver to the different Nanoled the capacity to feed the sectors or lines defined as emergency, making the visual change of color in each device that carries it or has level 2 control.

17. A projection system according to claim 7, regarding the remote emergency modulator CHARACTERIZED because it comprises a physical drive module that is installed in the external dependencies to the voltage inverter control modules in the equipment, as devices, these will activate each of the modules and will order the activation of the change of state for the elements that make up the system.

18. A projection system according to claim 17 CHARACTERIZED because it includes the activation of the portal and mobile applications, which will serve to monitor the status of each component and device inserted in the system as a whole.

19. A projection system according to claim 7 CHARACTERIZED because the bidirectional control creates a communication from one module to the other and vice versa, which orders and informs the emergency conditions of each one of them, activating the devices that are connected to the voltage inverter module and reported their status to the remote emergency module.

20. A projection system according to the preceding claims, CHARACTERIZED because in terms of claims 1, the system is shaped and generating the technique, that is, electrically powered sheets working together and in unison, controlled locally or remotely from the platform.

21. A projection system according to claim 1, wherein the electronic control module is in charge of electrically feeding and controlling this system.
